(19) United States
(12) Patent Application Publication
(10) Pub. No.: US 2026/0314599 A1
(43) Pub. Date: Oct. 15, 2026

(54) NEW USE OF PYDIFLUMETOFEN

(71) Applicant: SYNGENTA CROP PROTECTION AG, Basel (CH)

(72) Inventors: Feng LI, Beijing (CN); Lucas HUANG, Shanghai City (CN); Jingjing XU, Beijing (CN); Tinglong GUAN, Shanghai City (CN); Lianhong ZHANG, Beijing (CN)

(73) Assignee: SYNGENTA CROP PROTECTION AG, Basel (CH)

(21) Appl. No.: 19/104,155

(22) PCT Filed: Aug. 15, 2023
(86) PCT No.: PCT/EP2023/072469

§ 371 Date: Feb. 14, 2025

(30) Foreign Application Priority Data
Aug. 16, 2022 (WO) PCT/CN2022/112692

(51) Int. Cl. A01N 43/56; A01P 3/00

(52) U.S. Cl. CPC A01N 43/56; A01P 3/00

(57) ABSTRACT

The present invention relates to the use of N-methoxy (phenylethyl)-pyrazole carboxamides for the control of phytopathogenic diseases of useful plants, especially phytopathogenic fungi, and to a method of controlling such diseases, and/or fungi, on useful plants. In particular, the present invention relates to the use of 3-(difluoromethyl)-N-methoxy-1-methyl-N-[1-methyl-2-(2,4,6-trichloro-phenyl)ethyl]-1H-pyrazole-4-carboxamide (pydiflumetofen) for the control of Ustilaginoidea spp., in particular Ustilaginoidea virens on rice plants.

The present invention relates to the use of N-methoxy (phenylethyl)-pyrazole carboxamides for the control of phytopathogenic diseases of useful plants, especially phytopathogenic fungi, and to a method of controlling such diseases, and/or fungi, on useful plants. In particular, the present invention relates to the use of 3-(difluoromethyl)-N-methoxy-1-methyl-N-[1-methyl-2-(2,4,6-trichloro-phenyl)ethyl]-1H-pyrazole-4-carboxamide (pydiflumetofen) for the control of Ustilaginoidea spp., in particular Ustilaginoidea virens on rice plants.

It is known from WO2008/148570, WO 2010/063700, WO 2010/084078 and WO 2008/151828 that certain pyrazolyl-carboxamide derivatives have biological activity against phytopathogenic fungi. On the other hand various fungicidal compounds of different chemical classes are widely known as plant fungicides for application in various crops of cultivated plants.

Ustilaginoidea virens is a plant pathogen which causes the disease “false smut” of rice which is known to reduce both grain yield and grain quality. False smut primarily affects quality since the fungus produces brown “smut balls” that contaminate rice grain at harvest, i.e., the pathogen converts individual grains of the rice panicle into smut balls, the surface of which are covered by powdery chlamydospores during maturity. These are unsightly and must be removed before the rice is used if there are very many of these balls within a load. It also can cause problems for exported rice.

Ustilaginoidea virens has a unique life cycle; white hyphae are produced by the fungi after initial infection of the floral organs of the rice crop. As the infection matures with time, darker brownish green chlamydospores are produced on the rice spikelets. Additionally, sclerotia can be present towards the end of the fall season. During its life cycle, U. virens undergoes a sexual (ascospores) stage as well as an asexual (chlamydospores) stage. The chlamydospores are the main survival structure, and they can live in the soil for up to four months. The additional formation of sclerotia allows U. virens to survive even longer, almost up to a year. These sclerotia, which can be present either on or below the surface of the soil, mature to form an ascocarp (fruiting body). The ascospores from these fruiting bodies act as the primary source of infection to spread disease throughout the paddy field. The disease is most severe when environmental conditions such as high humidity (higher than 80%) and temperatures ranging from 25° C. to 30° C. are prevalent. Late sowing of the rice plants and high soil fertility, as well as large amounts of fertilizer in the soil lead to an increase in disease.

It is known from Chen Y. et al., Phytoparasitica, 2013, 41, 277-284 that ergosterol biosynthesis inhibitor (EBI) fungicides, such as prochloraz, difenoconazole, propiconazole, and tebuconazole, are extensively used (especially in China), for the control of rice diseases, such as rice sheath blight, rice blast, and false smut.

3-(Difluoromethyl)-N-methoxy-1-methyl-N-[1-methyl-2-(2,4,6-trichloro-phenyl)ethyl]-1H-pyrazole-4-carboxamide (known by its common name ‘pydiflumetofen’) described in WO 2010/063700 is a broad-spectrum foliar fungicide and the first example of the new group of N-methoxy-(phenylethyl)-pyrazole-carboxamides within the succinate dehydrogenase inhibitor (SDHI) class.

The present invention is based on the surprising finding that pydiflumetofen also exhibits a high level of activity Ustilaginoidea virens in rice plants.

Thus, in a first aspect the present invention relates to a method of controlling Ustilaginoidea virens on rice plants, said method comprising applying an effective amount of pydiflumetofen, to the plant, plant part, or to the locus thereof.

In another aspect, there is provided a method of controlling Ustilaginoidea virens on rice plants, said method comprising applying an effective amount of a composition comprising pydiflumetofen to the plant, plant part, or locus thereof.

In a further aspect, there is provided a use of pydiflumetofen, or an agrochemically acceptable salt, isomer, stereoisomer, diastereoisomer, enantiomer or tautomer thereof, to control Ustilaginoidea virens.

Pydiflumetofen and its preparation are described in WO 2010/063700, WO 2013/127764, and WO 2014/206855. The skilled person will appreciate that 3-(difluoromethyl)-N-methoxy-1-methyl-N-[1-methyl-2-(2,4,6-trichloro-phenyl)ethyl]-1H-pyrazole-4-carboxamide exists in two enantiomeric forms: 3-(difluoromethyl)-N-methoxy-1-methyl-N-[(1R)-1-methyl-2-(2,4,6-trichloro-phenyl)ethyl]-1H-pyrazole-4-carboxamide and 3-(difluoromethyl)-N-methoxy-1-methyl-N-[(1S)-1-methyl-2-(2,4,6-trichloro-phenyl)ethyl]-1H-pyrazole-4-carboxamide. Both enantiomers can be used for the control or suppression of phytopathogenic bacteria, individually, or as a racemate. The compound 3-(difluoromethyl)-N-methoxy-1-methyl-N-[1-methyl-2-(2,4,6-trichloro-phenyl)ethyl]-1H-pyrazole-4-carboxamide may be referred to herein by full name, ISO name, or as “the compound”.

The term “locus” as used herein means fields in or on which plants are growing, or where seeds of cultivated plants are sown, or where seed will be placed into the soil. It includes soil, seeds, and seedlings, as well as established vegetation.

The term “plants” refers to all physical parts of a plant, including seeds, seedlings, roots, stems, stalks and foliage.

The term “plant propagation material” as used herein is understood to denote generative parts of a useful plant, such as seeds, which can be used for the multiplication of the latter, and vegetative material, such as cuttings or tubers, for example potatoes. There may be mentioned for example seeds (in the strict sense), roots, fruits, tubers, bulbs, corms, rhizomes, and parts of plants. Germinated plants and young plants which are to be transplanted after germination or after emergence from the soil, may also be mentioned. These young plants may be protected before transplantation by a total or partial treatment by immersion in the compound. Preferably “plant propagation material” is understood to denote seeds and/or roots, more preferably seeds.

The term “reproductive growth stage” refers to the final stage of plant growth which follows germination and vegetative growth. During the reproductive growth stage, the plant's energy is directed to the production of flowers, fruits and seeds. Several growth stages help identify critical periods during the life cycle of the rice crop. They are generally separated into stages primarily associated either with vegetative or reproductive development. The vegetative phase occurs first and is associated with the six- to eight-week period following planting. The reproductive phase follows and is generally associated with the formation, development and maturation of the panicle and grain. Panicle initiation is the first stage in the reproductive phase of growth.

The reproductive growth stage typically starts at the beginning of stem elongation (BBCH 30). In rice, it includes panicle initiation (BBCH 30), panicle formation (BBCH 32), internode elongation (BBCH 34), spikelet differentiation (BBCH 35), meiosis (BBCH 39), booting (BBCH 41-49), and heading (BBCH 51). In wheat, the reproductive growth stage includes first node formation (BBCH 31), flag leaf formation (BBCH 37), booting (BBCH 41-49), and heading (BBCH 50-59).

The developing panicle is microscopic in size inside the stem, and panicle initiation can usually be associated with the beginning of stem internode formation. As the internode elongation stage begins, a build-up of chlorophyll occurs between the nodes that are to separate in the process of forming the first stem internode between them. This accumulation of chlorophyll imparts a green colour that encircles the developing internode producing a green ring or band. Thus, the internode elongation stage is sometimes referred to as the green ring stage. This stage is also referred to as first green ring because additional internodes that form on top of the first internode can also have the green ring effect as they begin to form. A total of five internodes can be produced in the formation of a stem of rice. As internode and panicle formation continue, the panicle differentiation stage occurs. Panicle differentiation is the first stage in the reproductive phase when the newly forming panicle becomes visible. At this stage, the panicle inside the stem has grown to approximately ⅛ inch. In the metric system, the length is approximately 2 millimetres, and the stage is sometimes referred to as the 2 mm panicle stage. The panicle continues to grow and develop inside the stem. As it does, the growth stage is referred to as booting and identified by the length of the panicle. When the panicle is up to 2 inches in length, the growth stage is early boot. Middle boot and late boot occur when the length of the panicle is 2 to 5 inches and 5 inches or greater, respectively. Up to this point, identification of the growth stages in the reproductive phase requires the stem to be dissected (split in half). During late boot, the panicle develops completely, and the growth stages that follow occur after the panicle has exerted and is visible outside the stem. The heading stage is noted when a portion of a panicle is observed growing out of the end of a rice stem. From this time forward, growth stages are based on the state of the panicle outside of the rice stem. Heading stages are identified by percentages, and the 50 percent heading stage occurs when 50 percent of rice stems are heading or headed (panicle completely emerged from the stem).

In one embodiment, the crop plants are at a BBCH growth stage from 30 to 51 at the time of treatment. In a further embodiment, the crop plants are at a BBCH growth stage from 41 to 49 at the time of treatment. In a further embodiment, the crop plants are at a BBCH 45 to 47. In one embodiment, the crop plants are treated after the start of the reproductive growth stage. In a further embodiment, the crop plants are treated before the heading growth stage, corresponding to BBCH growth stage 51.

In order to control Ustilaginoidea virens, pydiflumetofen is applied or administered in an “effective amount”, by which is meant any amount of pydiflumetofen that, upon suitable application, is sufficient to achieve the desired level of control of Ustilaginoidea virens.

Pydiflumetofen for the control of Ustilaginoidea virens can be used in unmodified form or, preferably, together with carriers and adjuvants conventionally employed in the art of formulation, and as described previously, for example, in WO 2010/063700. Typically, when used for fungal control, pydiflumetofen is applied to useful plants via foliar application. However, in order to control Ustilaginoidea virens, the preferred application methods are directly to the plant, the locus of the plant (e.g. the soil) or directly to plant propagation material (e.g. applied to the seed).

In a further embodiment, pydiflumetofen is applied to the plant, plant part, or locus thereof in the form of a fungicidal formulation. This formulation may contain one or more other desirable components including but not limited to liquid diluents, binders to serve as a matrix for the compounds as described herein, fillers for protecting the seeds, and plasticizers to improve flexibility, adhesion and/or spreadability of the coating.

The fungicidal formulation e.g. a composition comprising pydiflumetofen, and, if desired, a solid or liquid adjuvant or monomers for encapsulating the compound, may be prepared in a known manner, typically by mixing and/or grinding the compound with extenders, for example solvents, solid carriers and, optionally, surface active compounds (surfactants).

Typical rates of application per hectare is generally 1 g to 2000 g of pydiflumetofen per hectare, in particular 10 g to 1000 g/ha, preferably 10 to 800 g/ha, more preferably 20 g to 600 g/ha, and most preferably 40 g to 500 g/ha. In particular, pydiflumetofen is applied at 40 g to 400 g of active ingredient per hectare. In one embodiment, pydiflumetofen is applied at 50 g to 100 g of active ingredient per hectare. In one embodiment, pydiflumetofen is applied at 60 g to 75 g of active ingredient per hectare. When used for treating seeds or as a drenching agent, convenient rates of application are from 1 mg to 50 g of active substance per kg of seeds, preferably from 10 mg to 30 g of active substance per kg of seeds, and more preferably, from 10 mg to 1 g of active substance per kg of seeds.

In a further embodiment, pydiflumetofen is used in a foliar or a seed treatment composition.

The compositions of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Such compositions may be produced in conventional manner, e.g., by mixing the active ingredients with appropriate formulation inerts (diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least containing pydiflumetofen together with component (B) and (C), and optionally other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

Pydiflumetofen may be the sole active ingredient of a composition or it may be admixed with one or more additional active ingredients such as a pesticide, fungicide, synergist, herbicide or plant growth regulator where appropriate. An additional active ingredient may, in some cases, result in unexpected synergistic activities. Examples of suitable additional active ingredients include a compound selected from the group of substances consisting of petroleum oils, 1,1-bis(4-chlorophenyl)-2-ethoxyethanol, 2,4-dichlorophenyl benzenesulfonate, 2-fluoro-N-methyl-N-1-naphthylacetamide, 4-chlorophenyl phenyl sulfone, acetoprole, aldoxycarb, amidithion, amidothioate, amiton, amiton hydrogen oxalate, amitraz, aramite, arsenous oxide, azobenzene, azothoate, benomyl, benoxafos, benzyl benzoate, bixafen, brofenvalerate, bromocyclen, bromophos, bromopropylate, buprofezin, butocarboxim, butoxycarboxim, butylpyridaben, calcium polysulfide, camphechlor, carbanolate, carbophenothion, cymiazole, chinomethionat, chlorbenside, chlordimeform, chlordimeform hydrochloride, chlorfenethol, chlorfenson, chlorfensulfide, chlorobenzilate, chloromebuform, chloromethiuron, chloropropylate, chlorthiophos, cinerin I, cinerin II, cinerins, closantel, coumaphos, crotamiton, crotoxyphos, cufraneb, cyanthoate, DCPM, DDT, demephion, demephion-O, demephion-S, demeton-methyl, demeton-O, demeton-O-methyl, demeton-S, demeton-S-methyl, demeton-S-methylsulfon, dichlofluanid, dichlorvos, dicliphos, dienochlor, dimefox, dinex, dinex-diclexine, dinocap-4, dinocap-6, dinocton, dinopenton, dinosulfon, dinoterbon, dioxathion, diphenyl sulfone, disulfiram, DNOC, dofenapyn, doramectin, endothion, eprinomectin, ethoate-methyl, etrimfos, fenazaflor, fenbutatin oxide, fenothiocarb, fenpyrad, fenpyroximate, fenpyrazamine, fenson, fentrifanil, flubenzimine, flucycloxuron, fluenetil, fluorbenside, FMC 1137, formetanate, formetanate hydrochloride, formparanate, gamma-HCH, glyodin, halfenprox, hexadecyl cyclopropanecarboxylate, isocarbophos, jasmolin I, jasmolin II, jodfenphos, lindane, malonoben, mecarbam, mephosfolan, mesulfen, methacrifos, methyl bromide, metolcarb, mexacarbate, milbemycin oxime, mipafox, monocrotophos, morphothion, moxidectin, naled, 4-chloro-2-(2-chloro-2-methyl-propyl)-5-[(6-iodo-3-pyridyl) methoxy]pyridazin-3-one, nifluridide, nikkomycins, nitrilacarb, nitrilacarb 1:1 zinc chloride complex, omethoate, oxydeprofos, oxydisulfoton, pp′-DDT, parathion, permethrin, phenkapton, phosalone, phosfolan, phosphamidon, polychloroterpenes, polynactins, proclonol, promacyl, propoxur, prothidathion, prothoate, pyrethrin I, pyrethrin II, pyrethrins, pyridaphenthion, pyrimitate, quinalphos, quintiofos, R-1492, phosglycin, rotenone, schradan, sebufos, selamectin, sophamide, SSI-121, sulfiram, sulfluramid, sulfotep, sulfur, diflovidazin, tau-fluvalinate, TEPP, terbam, tetradifon, tetrasul, thiafenox, thiocarboxime, thiofanox, thiometon, thioquinox, thuringiensin, triamiphos, triarathene, triazophos, triazuron, trifenofos, trinactin, vamidothion, vaniliprole, bethoxazin, copper dioctanoate, copper sulfate, cybutryne, dichlone, dichlorophen, endothal, fentin, hydrated lime, nabam, quinoclamine, quinonamid, simazine, triphenyltin acetate, triphenyltin hydroxide, crufomate, piperazine, thiophanate, chloralose, fenthion, pyridin-4-amine, strychnine, 1-hydroxy-1H-pyridine-2-thione, 4-(quinoxalin-2-ylamino)benzenesulfonamide, 8-hydroxyquinoline sulfate, bronopol, copper hydroxide, cresol, dipyrithione, dodicin, fenaminosulf, formaldehyde, hydrargaphen, kasugamycin, kasugamycin hydrochloride hydrate, nickel bis(dimethyldithiocarbamate), nitrapyrin, octhilinone, oxolinic acid, oxytetracycline, potassium hydroxyquinoline sulfate, probenazole, streptomycin, streptomycin sesquisulfate, tecloftalam, thiomersal, Adoxophyes orana GV, Agrobacterium radiobacter, Amblyseius spp., Anagrapha falcifera NPV, Anagrus atomus, Aphelinus abdominalis, Aphidius colemani, Aphidoletes aphidimyza, Autographa californica NPV, Bacillus sphaericus Neide, Beauveria brongniartii, Chrysoperla carnea, Cryptolaemus montrouzieri, Cydia pomonella GV, Dacnusa sibirica, Diglyphus isaea, Encarsia formosa, Eretmocerus eremicus, Heterorhabditis bacteriophora and H. megidis, Hippodamia convergens, Leptomastix dactylopii, Macrolophus caliginosus, Mamestra brassicae NPV, Metaphycus helvolus, Metarhizium anisopliae var. acridum, Metarhizium anisopliae var. anisopliae, Neodiprion sertifer NPV and N. lecontei NPV, Orius spp., Paecilomyces fumosoroseus, Phytoseiulus persimilis, Steinernema bibionis, Steinernema carpocapsae, Steinernema feltiae, Steinernema glaseri, Steinernema riobrave, Steinernema riobravis, Steinernema scapterisci, Steinernema spp., Trichogramma spp., Typhlodromus occidentalis, Verticillium lecanii, apholate, bisazir, busulfan, dimatif, hemel, hempa, metepa, methiotepa, methyl apholate, morzid, penfluron, tepa, thiohempa, thiotepa, tretamine, uredepa, (E)-dec-5-en-1-yl acetate with (E)-dec-5-en-1-ol, (E)-tridec-4-en-1-yl acetate, (E)-6-methylhept-2-en-4-ol, (E,Z)-tetradeca-4,10-dien-1-yl acetate, (Z)-dodec-7-en-1-yl acetate, (Z)-hexadec-11-enal, (Z)-hexadec-11-en-1-yl acetate, (Z)-hexadec-13-en-11-yn-1-yl acetate, (Z)-icos-13-en-10-one, (Z)-tetradec-7-en-1-al, (Z)-tetradec-9-en-1-ol, (Z)-tetradec-9-en-1-yl acetate, (7E,9Z)-dodeca-7,9-dien-1-yl acetate, (9Z,11E)-tetradeca-9,11-dien-1-yl acetate, (9Z,12E)-tetradeca-9,12-dien-1-yl acetate, 14-methyloctadec-1-ene, 4-methylnonan-5-ol with 4-methylnonan-5-one, alpha-multistriatin, brevicomin, codlelure, codlemone, cuelure, disparlure, dodec-8-en-1-yl acetate, dodec-9-en-1-yl acetate, dodeca-8, 10-dien-1-yl acetate, dominicalure, ethyl 4-methyloctanoate, eugenol, frontalin, grandlure, grandlure I, grandlure II, grandlure III, grandlure IV, hexalure, ipsdienol, ipsenol, japonilure, lineatin, litlure, looplure, medlure, megatomoic acid, methyl eugenol, muscalure, octadeca-2,13-dien-1-yl acetate, octadeca-3,13-dien-1-yl acetate, orfralure, oryctalure, ostramone, siglure, sordidin, sulcatol, tetradec-11-en-1-yl acetate, trimedlure, trimedlure A, trimedlure B1, trimedlure B2, trimedlure C, trunc-call, 2-(octylthio) ethanol, butopyronoxyl, butoxy (polypropylene glycol), dibutyl adipate, dibutyl phthalate, dibutyl succinate, diethyltoluamide, dimethyl carbate, dimethyl phthalate, ethyl hexanediol, hexamide, methoquin-butyl, methylneodecanamide, oxamate, picaridin, 1-dichloro-1-nitroethane, 1,1-dichloro-2,2-bis(4-ethylphenyl) ethane, 1,2-dichloropropane with 1,3-dichloropropene, 1-bromo-2-chloroethane, 2,2,2-trichloro-1-(3,4-dichlorophenyl)ethyl acetate, 2,2-dichlorovinyl 2-ethylsulfinylethyl methyl phosphate, 2-(1,3-dithiolan-2-yl)phenyl dimethylcarbamate, 2-(2-butoxyethoxy)ethyl thiocyanate, 2-(4,5-dimethyl-1,3-dioxolan-2-yl)phenyl methylcarbamate, 2-(4-chloro-3,5-xylyloxy) ethanol, 2-chlorovinyl diethyl phosphate, 2-imidazolidone, 2-isovalerylindan-1,3-dione, 2-methyl(prop-2-ynyl)aminophenyl methylcarbamate, 2-thiocyanatoethyl laurate, 3-bromo-1-chloroprop-1-ene, 3-methyl-1-phenylpyrazol-5-yl dimethylcarbamate, 4-methyl(prop-2-ynyl)amino-3,5-xylyl methylcarbamate, 5,5-dimethyl-3-oxocyclohex-1-enyl dimethylcarbamate, acethion, acrylonitrile, aldrin, allosamidin, allyxycarb, alpha-ecdysone, aluminium phosphide, aminocarb, anabasine, athidathion, azamethiphos, Bacillus thuringiensis delta endotoxins, barium hexafluorosilicate, barium polysulfide, barthrin, Bayer 22/190, Bayer 22408, beta-cyfluthrin, beta-cypermethrin, bioethanomethrin, biopermethrin, bis(2-chloroethyl) ether, borax, bromfenvinfos, bromo-DDT, bufencarb, butacarb, butathiofos, butonate, calcium arsenate, calcium cyanide, carbon disulfide, carbon tetrachloride, cartap hydrochloride, cevadine, chlorbicyclen, chlordane, chlordecone, chloroform, chloropicrin, chlorphoxim, chlorprazophos, cis-resmethrin, cismethrin, clocythrin, copper acetoarsenite, copper arsenate, copper oleate, coumithoate, cryolite, CS 708, cyanofenphos, cyanophos, cyclethrin, cythioate, d-tetramethrin, DAEP, dazomet, decarbofuran, diamidafos, dicapthon, dichlofenthion, dicresyl, dicyclanil, dieldrin, diethyl 5-methylpyrazol-3-yl phosphate, dilor, dimefluthrin, dimetan, dimethrin, dimethylvinphos, dimetilan, dinoprop, dinosam, dinoseb, diofenolan, dioxabenzofos, dithicrofos, DSP, ecdysterone, EI 1642, EMPC, EPBP, etaphos, ethiofencarb, ethyl formate, ethylene dibromide, ethylene dichloride, ethylene oxide, EXD, fenchlorphos, fenethacarb, fenitrothion, fenoxacrim, fenpirithrin, fensulfothion, fenthion-ethyl, flucofuron, fosmethilan, fospirate, fosthietan, furathiocarb, furethrin, guazatine, guazatine acetates, sodium tetrathiocarbonate, halfenprox, HCH, HEOD, heptachlor, heterophos, HHDN, hydrogen cyanide, hyquincarb, IPSP, isazofos, isobenzan, isodrin, isofenphos, isolane, isoprothiolane, isoxathion, juvenile hormone I, juvenile hormone II, juvenile hormone III, kelevan, kinoprene, lead arsenate, leptophos, lirimfos, lythidathion, m-cumenyl methylcarbamate, magnesium phosphide, mazidox, mecarphon, menazon, mercurous chloride, mesulfenfos, metam, metam-potassium, metam-sodium, methanesulfonyl fluoride, methocrotophos, methoprene, methothrin, methoxychlor, methyl isothiocyanate, methylchloroform, methylene chloride, metoxadiazone, mirex, naftalofos, naphthalene, NC-170, nicotine, nicotine sulfate, nithiazine, nornicotine, O-5-dichloro-4-iodophenyl O-ethyl ethylphosphonothioate, O,O-diethyl O-4-methyl-2-oxo-2H-chromen-7-yl phosphorothioate, O,O-diethyl O-6-methyl-2-propylpyrimidin-4-yl phosphorothioate, O,O,O′,O′-tetrapropyl dithiopyrophosphate, oleic acid, para-dichlorobenzene, parathion-methyl, pentachlorophenol, pentachlorophenyl laurate, PH 60-38, phenkapton, phosnichlor, phosphine, phoxim-methyl, pirimetaphos, polychlorodicyclopentadiene isomers, potassium arsenite, potassium thiocyanate, precocene I, precocene II, precocene III, primidophos, profluthrin, promecarb, prothiofos, pyrazophos, pyresmethrin, quassia, quinalphos-methyl, quinothion, rafoxanide, resmethrin, rotenone, kadethrin, ryania, ryanodine, sabadilla, schradan, sebufos, SI-0009, thiapronil, sodium arsenite, sodium cyanide, sodium fluoride, sodium hexafluorosilicate, sodium pentachlorophenoxide, sodium selenate, sodium thiocyanate, sulcofuron, sulcofuron-sodium, sulfuryl fluoride, sulprofos, tar oils, tazimcarb, TDE, tebupirimfos, temephos, terallethrin, tetrachloroethane, thicrofos, thiocyclam, thiocyclam hydrogen oxalate, thionazin, thiosultap, thiosultap-sodium, tralomethrin, transpermethrin, triazamate, trichlormetaphos-3, trichloronat, trimethacarb, tolprocarb, triclopyricarb, triprene, veratridine, veratrine, XMC, zetamethrin, zinc phosphide, zolaprofos, meperfluthrin, tetramethylfluthrin, bis(tributyltin) oxide, bromoacetamide, ferric phosphate, niclosamide-olamine, tributyltin oxide, pyrimorph, trifenmorph, 1,2-dibromo-3-chloropropane, 1,3-dichloropropene, 3,4-dichlorotetrahydrothiophene 1,1-dioxide, 3-(4-chlorophenyl)-5-methylrhodanine, 5-methyl-6-thioxo-1,3,5-thiadiazinan-3-ylacetic acid, 6-isopentenylaminopurine, anisiflupurin, benclothiaz, cytokinins, DCIP, furfural, isamidofos, kinetin, Myrothecium verrucaria composition, tetrachlorothiophene, xylenols, potassium ethylxanthate, acibenzolar, acibenzolar-S-methyl, Reynoutria sachalinensis extract, alpha-chlorohydrin, antu, barium carbonate, bisthiosemi, brodifacoum, bromadiolone, bromethalin, chlorophacinone, cholecalciferol, coumachlor, coumafuryl, coumatetralyl, crimidine, difenacoum, difethialone, diphacinone, ergocalciferol, flocoumafen, fluoroacetamide, flupropadine, flupropadine hydrochloride, norbormide, phosacetim, phosphorus, pindone, pyrinuron, scilliroside, sodium fluoro-acetate, thallium sulfate, warfarin, 2-(2-butoxyethoxy)ethyl piperonylate, 5-(1,3-benzodioxol-5-yl)-3-hexylcyclohex-2-enone, farnesol with nerolidol, verbutin, MGK 264, piperonyl butoxide, piprotal, propyl isomer, S421, sesamex, sesasmolin, sulfoxide, anthraquinone, copper naphthenate, copper oxychloride, dicyclopentadiene, thiram, zinc naphthenate, ziram, imanin, ribavirin, chloroinconazide, mercuric oxide, thiophanate-methyl, azaconazole, bitertanol, bromuconazole, cyproconazole, difenoconazole, diniconazole, epoxiconazole, fenbuconazole, fluquinconazole, flusilazole, flutriafol, furametpyr, hexaconazole, imazalil, imibenconazole, ipconazole, metconazole, myclobutanil, paclobutrazole, pefurazoate, penconazole, prothioconazole, pyrifenox, prochloraz, propiconazole, pyrisoxazole, simeconazole, tebuconazole, tetraconazole, triadimefon, triadimenol, triflumizole, triticonazole, ancymidol, fenarimol, nuarimol, bupirimate, dimethirimol, ethirimol, dodemorph, fenpropidin, fenpropimorph, spiroxamine, tridemorph, cyprodinil, mepanipyrim, pyrimethanil, fenpiclonil, fludioxonil, benalaxyl, furalaxyl, metalaxyl, R-metalaxyl, ofurace, oxadixyl, carbendazim, debacarb, fuberidazole, thiabendazole, chlozolinate, dichlozoline, myclozoline, procymidone, vinclozoline, boscalid, carboxin, fenfuram, flutolanil, mepronil, oxycarboxin, penthiopyrad, thifluzamide, dodine, iminoctadine, azoxystrobin, dimoxystrobin, enestroburin, fenaminstrobin, flufenoxystrobin, fluoxastrobin, kresoxim-methyl, metominostrobin, trifloxystrobin, orysastrobin, picoxystrobin, pyraclostrobin, pyrametostrobin, pyraoxystrobin, ferbam, mancozeb, maneb, metiram, propineb, zineb, captafol, captan, fluoroimide, folpet, tolylfluanid, bordeaux mixture, copper oxide, mancopper, oxine-copper, nitrothal-isopropyl, edifenphos, iprobenphos, phosdiphen, tolclofos-methyl, anilazine, benthiavalicarb, blasticidin-S, chloroneb, chlorothalonil, cyflufenamid, cymoxanil, cyclobutrifluram, diclocymet, diclomezine, dicloran, diethofencarb, dimethomorph, flumorph, dithianon, ethaboxam, etridiazole, famoxadone, fenamidone, fenoxanil, ferimzone, fluazinam, flumetylsulforim, fluopicolide, fluoxytioconazole, flusulfamide, fluxapyroxad, fenhexamid, fosetyl-aluminium, hymexazol, iprovalicarb, cyazofamid, methasulfocarb, metrafenone, pencycuron, phthalide, polyoxins, propamocarb, pyribencarb, proquinazid, pyroquilon, pyriofenone, quinoxyfen, quintozene, tiadinil, triazoxide, tricyclazole, triforine, validamycin, valifenalate, zoxamide, mandipropamid, flubeneteram, isopyrazam, sedaxane, benzovindiflupyr, pydiflumetofen, 3-difluoromethyl-1-methyl-1H-pyrazole-4-carboxylic acid (3′,4′,5′-trifluoro-biphenyl-2-yl)-amide, isoflucypram, isotianil, dipymetitrone, 6-ethyl-5,7-dioxo-pyrrolo[4,5][1,4]dithiino [1,2-c]isothiazole-3-carbonitrile, 2-(difluoromethyl)-N-[3-ethyl-1,1-dimethyl-indan-4-yl]pyridine-3-carboxamide, 4-(2,6-difluorophenyl)-6-methyl-5-phenyl-pyridazine-3-carbonitrile, (R)-3-(difluoromethyl)-1-methyl-N-[1,1,3-trimethylindan-4-yl]pyrazole-4-carboxamide, 4-(2-bromo-4-fluoro-phenyl)-N-(2-chloro-6-fluoro-phenyl)-2,5-dimethyl-pyrazol-3-amine, 4-(2-bromo-4-fluorophenyl)-N-(2-chloro-6-fluorophenyl)-1,3-dimethyl-1H-pyrazol-5-amine, fluindapyr, coumethoxystrobin (jiaxiangjunzhi), Ivbenmixianan, dichlobentiazox, mandestrobin, 3-(4,4-difluoro-3,4-dihydro-3,3-dimethylisoquinolin-1-yl) quinolone, 2-[2-fluoro-6-[(8-fluoro-2-methyl-3-quinolyl)oxy]phenyl]propan-2-ol, oxathiapiprolin, tert-butyl N-[6-[(1-methyltetrazol-5-yl)-phenyl-methylene]amino]oxymethyl]-2-pyridyl]carbamate, pyraziflumid, inpyrfluxam, trolprocarb, mefentrifluconazole, ipfentrifluconazole, 2-(difluoromethyl)-N-[(3R)-3-ethyl-1,1-dimethyl-indan-4-yl]pyridine-3-carboxamide, N′-(2,5-dimethyl-4-phenoxy-phenyl)-N-ethyl-N-methyl-formamidine, N′-[4-(4,5-dichlorothiazol-2-yl)oxy-2,5-dimethyl-phenyl]-N-ethyl-N-methyl-formamidine, [2-[3-[2-[1-[2-[3,5-bis(difluoromethyl) pyrazol-1-yl]acetyl]-4-piperidyl]thiazol-4-yl]-4,5-dihydroisoxazol-5-yl]-3-chloro-phenyl]methanesulfonate, but-3-ynyl N-[6-[(Z)-[(1-methyltetrazol-5-yl)-phenyl-methylene]amino]oxymethyl]-2-pyridyl]carbamate, methyl N-[5-[4-(2,4-dimethylphenyl)triazol-2-yl]-2-methyl-phenyl]methyl]carbamate, 3-chloro-6-methyl-5-phenyl-4-(2,4,6-trifluorophenyl)pyridazine, pyridachlometyl, 3-(difluoromethyl)-1-methyl-N-[1,1,3-trimethylindan-4-yl]pyrazole-4-carboxamide, 1-[2-[1-(4-chlorophenyl) pyrazol-3-yl]oxymethyl]-3-methyl-phenyl]-4-methyl-tetrazol-5-one, 1-methyl-4-[3-methyl-2-[2-methyl-4-(3,4,5-trimethylpyrazol-1-yl) phenoxy]methyl]phenyl]tetrazol-5-one, aminopyrifen, ametoctradin, amisulbrom, penflufen, (Z,2E)-5-[1-(4-chlorophenyl) pyrazol-3-yl]oxy-2-methoxyimino-N,3-dimethyl-pent-3-enamide, florylpicoxamid, fenpicoxamid, metarylpicoxamid, tebufloquin, ipflufenoquin, quinofumelin, isofetamid, ethyl 1-[4-[2-(trifluoromethyl)-1,3-dioxolan-2-yl]methoxy]phenyl]methyl]pyrazole-3-carboxylate (may be prepared from the methods described in WO 2020/056090), ethyl 1-[4-[(Z)-2-ethoxy-3,3,3-trifluoro-prop-1-enoxy]phenyl]methyl]pyrazole-3-carboxylate (may be prepared from the methods described in WO 2020/056090), methyl N-[4-[1-(4-cyclopropyl-2,6-difluorophenyl) pyrazol-4-yl]-2-methyl-phenyl]methyl]carbamate (may be prepared from the methods described in WO 2020/097012), methyl N-[4-[1-(2,6-difluoro-4-isopropyl-phenyl) pyrazol-4-yl]-2-methyl-phenyl]methyl]carbamate (may be prepared from the methods described in WO 2020/097012), 6-chloro-3-(3-cyclopropyl-2-fluoro-phenoxy)-N-[2-(2,4-dimethylphenyl)-2,2-difluoro-ethyl]-5-methyl-pyridazine-4-carboxamide (may be prepared from the methods described in WO 2020/109391), 6-chloro-N-[2-(2-chloro-4-methyl-phenyl)-2,2-difluoro-ethyl]-3-(3-cyclopropyl-2-fluoro-phenoxy)-5-methyl-pyridazine-4-carboxamide (may be prepared from the methods described in WO 2020/109391), 6-chloro-3-(3-cyclopropyl-2-fluoro-phenoxy)-N-[2-(3,4-dimethylphenyl)-2,2-difluoro-ethyl]-5-methyl-pyridazine-4-carboxamide (may be prepared from the methods described in WO 2020/109391), N-[2-[2,4-dichloro-phenoxy]phenyl]-3-(difluoromethyl)-1-methyl-pyrazole-4-carboxamide, N-[2-[2-chloro-4-(trifluoromethyl) phenoxy]phenyl]-3-(difluoromethyl)-1-methyl-pyrazole-4-carboxamide, benzothiostrobin, phenamacril, 5-amino-1,3,4-thiadiazole-2-thiol zinc salt (2:1), fluopyram, flufenoxadiazam, flutianil, fluopimomide, pyrapropoyne, picarbutrazox, 2-(difluoromethyl)-N-(3-ethyl-1,1-dimethyl-indan-4-yl)pyridine-3-carboxamide, 2-(difluoromethyl)-N-((3R)-1, 1, 3-trimethylindan-4-yl)pyridine-3-carboxamide, 4-[6-[2-(2,4-difluorophenyl)-1,1-difluoro-2-hydroxy-3-(1,2,4-triazol-1-yl) propyl]-3-pyridyl]oxy]benzonitrile, metyltetraprole, 2-(difluoromethyl)-N-((3R)-1, 1, 3-trimethylindan-4-yl)pyridine-3-carboxamide, α-(1, 1-dimethylethyl)-α-[4′-(trifluoromethoxy) [1,1′-biphenyl]-4-yl]-5-pyrimidinemethanol, fluoxapiprolin, enoxastrobin, methyl (Z)-3-methoxy-2-[2-methyl-5-[4-(trifluoromethyl)triazol-2-yl]phenoxy]prop-2-enoate, methyl (Z)-3-methoxy-2-[2-methyl-5-(4-propyltriazol-2-yl) phenoxy]prop-2-enoate, methyl (Z)-2-[5-(3-isopropylpyrazol-1-yl)-2-methyl-phenoxy]-3-methoxy-prop-2-enoate, methyl (Z)-3-methoxy-2-[2-methyl-5-(3-propylpyrazol-1-yl) phenoxy]prop-2-enoate, methyl (Z)-3-methoxy-2-[2-methyl-5-[3-(trifluoromethyl) pyrazol-1-yl]phenoxy]prop-2-enoate (these compounds may be prepared from the methods described in WO2020/079111), methyl (Z)-2-(5-cyclohexyl-2-methyl-phenoxy)-3-methoxy-prop-2-enoate, methyl (Z)-2-(5-cyclopentyl-2-methyl-phenoxy)-3-methoxy-prop-2-enoate (these compounds may be prepared from the methods described in WO2020/193387), 4-[[6-[2-(2,4-difluorophenyl)-1,1-difluoro-2-hydroxy-3-(1,2,4-triazol-1-yl) propyl]-3-pyridyl]oxy]benzonitrile, 4-[[6-[2-(2,4-difluorophenyl)-1,1-difluoro-2-hydroxy-3-(5-sulfanyl-1,2,4-triazol-1-yl) propyl]-3-pyridyl]oxy]benzonitrile, 4-[6-[2-(2,4-difluorophenyl)-1,1-difluoro-2-hydroxy-3-(5-thioxo-4H-1,2,4-triazol-1-yl) propyl]-3-pyridyl]oxy]benzonitrile, trinexapac, coumoxystrobin, zhongshengmycin, thiodiazole copper, zinc thiazole, amectotractin, iprodione, seboctylamine, N′-[5-bromo-2-methyl-6-[(1S)-1-methyl-2-propoxy-ethoxy]-3-pyridyl]-N-ethyl-N-methyl-formamidine, N′-[5-bromo-2-methyl-6-[(1R)-1-methyl-2-propoxy-ethoxy]-3-pyridyl]-N-ethyl-N-methyl-formamidine, N′-[5-bromo-2-methyl-6-(1-methyl-2-propoxy-ethoxy)-3-pyridyl]-N-ethyl-N-methyl-formamidine, N′-[5-chloro-2-methyl-6-(1-methyl-2-propoxy-ethoxy)-3-pyridyl]-N-ethyl-N-methyl-formamidine, N′-[5-bromo-2-methyl-6-(1-methyl-2-propoxy-ethoxy)-3-pyridyl]-N-isopropyl-N-methyl-formamidine (these compounds may be prepared from the methods described in WO2015/155075); N′-[5-bromo-2-methyl-6-(2-propoxypropoxy)-3-pyridyl]-N-ethyl-N-methyl-formamidine (this compound may be prepared from the methods described in IPCOM000249876D); N-isopropyl-N′-[5-methoxy-2-methyl-4-(2,2,2-trifluoro-1-hydroxy-1-phenyl-ethyl)phenyl]-N-methyl-formamidine, N′-[4-(1-cyclopropyl-2,2,2-trifluoro-1-hydroxy-ethyl)-5-methoxy-2-methyl-phenyl]-N-isopropyl-N-methyl-formamidine (these compounds may be prepared from the methods described in WO2018/228896); N-ethyl-N′-[5-methoxy-2-methyl-4-[(2-trifluoromethyl) oxetan-2-yl]phenyl]-N-methyl-formamidine, N-ethyl-N′-[5-methoxy-2-methyl-4-[(2-trifuoromethyl)tetrahydrofuran-2-yl]phenyl]-N-methyl-formamidine (these compounds may be prepared from the methods described in WO2019/110427); N-[(1R)-1-benzyl-3-chloro-1-methyl-but-3-enyl]-8-fluoro-quinoline-3-carboxamide, N-[(1S)-1-benzyl-3-chloro-1-methyl-but-3-enyl]-8-fluoro-quinoline-3-carboxamide, N-[(1R)-1-benzyl-3,3,3-trifluoro-1-methyl-propyl]-8-fluoro-quinoline-3-carboxamide, N-[(1S)-1-benzyl-3,3,3-trifluoro-1-methyl-propyl]-8-fluoro-quinoline-3-carboxamide, N-[(1R)-1-benzyl-1,3-dimethyl-butyl]-7,8-difluoro-quinoline-3-carboxamide, N-[(1S)-1-benzyl-1,3-dimethyl-butyl]-7,8-difluoro-quinoline-3-carboxamide, 8-fluoro-N-[(1R)-1-[(3-fluorophenyl)methyl]-1,3-dimethyl-butyl]quinoline-3-carboxamide, 8-fluoro-N-[(1S)-1-[(3-fluorophenyl)methyl]-1,3-dimethyl-butyl]quinoline-3-carboxamide, N-[(1R)-1-benzyl-1,3-dimethyl-butyl]-8-fluoro-quinoline-3-carboxamide, N-[(1S)-1-benzyl-1,3-dimethyl-butyl]-8-fluoro-quinoline-3-carboxamide, N-((1R)-1-benzyl-3-chloro-1-methyl-but-3-enyl)-8-fluoro-quinoline-3-carboxamide, N-((1S)-1-benzyl-3-chloro-1-methyl-but-3-enyl)-8-fluoro-quinoline-3-carboxamide (these compounds may be prepared from the methods described in WO2017/153380); 1-(6,7-dimethylpyrazolo[1,5-a]pyridin-3-yl)-4,4,5-trifluoro-3,3-dimethyl-isoquinoline, 1-(6,7-dimethylpyrazolo[1,5-a]pyridin-3-yl)-4,4,6-trifluoro-3,3-dimethyl-isoquinoline, 4,4-difluoro-3,3-dimethyl-1-(6-methylpyrazolo[1,5-a]pyridin-3-yl) isoquinoline, 4,4-difluoro-3,3-dimethyl-1-(7-methylpyrazolo[1,5-a]pyridin-3-yl) isoquinoline, 1-(6-chloro-7-methyl-pyrazolo[1,5-a]pyridin-3-yl)-4,4-difluoro-3,3-dimethyl-isoquinoline (these compounds may be prepared from the methods described in WO2017/025510); 1-(4,5-dimethylbenzimidazol-1-yl)-4,4,5-trifluoro-3,3-dimethyl-isoquinoline, 1-(4,5-dimethylbenzimidazol-1-yl)-4,4-difluoro-3,3-dimethyl-isoquinoline, 6-chloro-4,4-difluoro-3,3-dimethyl-1-(4-methylbenzimidazol-1-yl) isoquinoline, 4,4-difluoro-1-(5-fluoro-4-methyl-benzimidazol-1-yl)-3,3-dimethyl-isoquinoline, 3-(4,4-difluoro-3,3-dimethyl-1-isoquinolyl)-7,8-dihydro-6H-cyclopenta[e]benzimidazole (these compounds may be prepared from the methods described in WO2016/156085); N-methoxy-N-[4-[5-(trifluoromethyl)-1,2,4-oxadiazol-3-yl]phenyl]methyl]cyclopropanecarboxamide, N,2-dimethoxy-N-[4-[5-(trifluoromethyl)-1,2,4-oxadiazol-3-yl]phenyl]methyl]propanamide, N-ethyl-2-methyl-N-[[4-[5-(trifluoromethyl)-1,2,4-oxadiazol-3-yl]phenyl]methyl]propanamide, 1-methoxy-3-methyl-1-[4-[5-(trifluoromethyl)-1,2,4-oxadiazol-3-yl]phenyl]methyl]urea, 1,3-dimethoxy-1-[[4-[5-(trifluoromethyl)-1,2,4-oxadiazol-3-3-ethyl-1-methoxy-1-[4-[5-(trifluoromethyl)-1,2,4-oxadiazol-3-yl]phenyl]methyl]urea, yl]phenyl]methyl]urea, N-[4-[5-(trifluoromethyl)-1,2,4-oxadiazol-3-yl]phenyl]methyl]propanamide, 4,4-dimethyl-2-[4-[5-(trifluoromethyl)-1,2,4-oxadiazol-3-yl]phenyl]methyl]isoxazolidin-3-one, 5,5-dimethyl-2-[4-[5-(trifluoromethyl)-1,2,4-oxadiazol-3-yl]phenyl]methyl]isoxazolidin-3-one, ethyl 1-[[4-[5-(trifluoromethyl)-1,2,4-oxadiazol-3-yl]phenyl]methyl]pyrazole-4-carboxylate, N,N-dimethyl-1-[4-[5-(trifluoromethyl)-1,2,4-oxadiazol-3-yl]phenyl]methyl]-1,2,4-triazol-3-amine (these compounds may be prepared from the methods described in WO 2017/055473, WO 2017/055469, WO 2017/093348 and WO 2017/118689); 2-[6-(4-chlorophenoxy)-2-(trifluoromethyl)-3-pyridyl]-1-(1,2,4-triazol-1-yl) propan-2-ol (this compound may be prepared from the methods described in WO 2017/029179); 2-[6-(4-bromophenoxy)-2-(trifluoromethyl)-3-pyridyl]-1-(1,2,4-triazol-1-yl) propan-2-ol (this compound may be prepared from the methods described in WO 2017/029179); 3-[2-(1-chlorocyclopropyl)-3-(2-fluorophenyl)-2-hydroxy-propyl]imidazole-4-carbonitrile (this compound may be prepared from the methods described in WO 2016/156290); 3-[2-(1-chlorocyclopropyl)-3-(3-chloro-2-fluoro-phenyl)-2-hydroxy-propyl]imidazole-4-carbonitrile (this compound may be prepared from the methods described in WO 2016/156290); (4-phenoxyphenyl)methy l 2-amino-6-methyl-pyridine-3-carboxylate (this compound may be prepared from the methods described in WO 2014/006945); 2,6-Dimethyl-1H,5H-[1,4]dithiino[2,3-c: 5,6-c′]dipyrrole-1,3,5,7 (2H,6H)-tetrone (this compound may be prepared from the methods described in WO 2011/138281)N-methyl-4-[5-(trifluoromethyl)-1,2,4-oxadiazol-3-yl]benzenecarbothioamide; N-methyl-4-[5-(trifluoromethyl)-1,2,4-oxadiazol-3-yl]benzamide; (Z,2E)-5-[1-(2,4-dichlorophenyl) pyrazol-3-yl]oxy-2-methoxyimino-N,3-dimethyl-pent-3-enamide (this compound may be prepared from the methods described in WO 2018/153707); N′-(2-chloro-5-methyl-4-phenoxy-phenyl)-N-ethyl-N-methyl-formamidine; N′-[2-chloro-4-(2-fluorophenoxy)-5-methyl-phenyl]-N-ethyl-N-methyl-formamidine (this compound may be prepared from the methods described in WO 2016/202742); 2-(difluoromethyl)-N-[(3S)-3-ethyl-1,1-dimethyl-indan-4-yl]pyridine-3-carboxamide (this compound may be prepared from the methods described in WO 2014/095675); (5-methyl-2-pyridyl)-[4-[5-(trifluoromethyl)-1,2,4-oxadiazol-3-yl]phenyl]methanone, (3-methylisoxazol-5-yl)-[4-[5-(trifluoromethyl)-1,2,4-oxadiazol-3-yl]phenyl]methanone (these compounds may be prepared from the methods described in WO 2017/220485); 2-oxo-N-propyl-2-[4-[5-(trifluoromethyl)-1,2,4-oxadiazol-3-yl]phenyl]acetamide (this compound may be prepared from the methods described in WO 2018/065414); ethyl 1-[5-[5-(trifluoromethyl)-1,2,4-oxadiazol-3-yl]-2-thienyl]methyl]pyrazole-4-carboxylate (this compound may be prepared from the methods described in WO 2018/158365); 2,2-difluoro-N-methyl-2-[4-[5-(trifluoromethyl)-1,2,4-oxadiazol-3-yl]phenyl]acetamide, N-[(E)-methoxyiminomethyl]-4-[5-(trifluoromethyl)-1,2,4-oxadiazol-3-yl]benzamide, N-[(Z)-methoxyiminomethyl]-4-[5-(trifluoromethyl)-1,2,4-oxadiazol-3-yl]benzamide, N-[N-methoxy-C-methyl-carbonimidoyl]-4-[5-(trifluoromethyl)-1,2,4-oxadiazol-3-yl]benzamide (these compounds may be prepared from the methods described in WO 2018/202428).

The present invention will now be described with reference to the following examples, which are by way of illustration and do not limit the scope of the invention in any way. The following examples demonstrate the ability of pydiflumetofen to control Ustilaginoidea virens.

### BIOLOGICAL EXAMPLES

### Example 1-In Vitro Activity of Pydiflumetofen Against Rice False Smut (Caused by Ustilaginoidea Virens) by Mycelial Growth Method

Ustilaginoidea virens, the pathogens that cause rice false smut, were isolated from infected rice tissues and stored at 4° C. Pathogen was applied to the PSA plate and incubated at 28° C. for 7 days. Mycelial plugs at the edge of the colony were prepared by hole puncher with a diameter of 5 mm. Pydiflumetofen was dissolved into dimethyl sulfoxide (DMSO) to get 4×10⁴ μg/mL for stock solution. Mixing PSA culture medium with stock solution of pydiflumetofen to get different series of concentration: 0, 0.0005, 0.0010, 0.0025, 0.0040, 0.0055, and 0.007 μg/mL. Using the mycelial growth method, the mycelial plugs were shifted to the center of PSA medium plates containing different pydiflumetofen concentrations. After being cultured in an incubator at 28° C. for 14 days, the diameters of every mycelial colony on PSA plates were measured and the inhibition rates were calculated. EC₅₀ values were determined by the fitted regression line of the log-transformed percentage inhibition plotted against the log-transformed fungicide concentration.

TABLE 1
In vitro activity of pydiflumetofen against rice
false smut (caused by Ustilaginoidea virens)

| Pydiflumetofen (μg/mL) | | 0 | 0.0070 | 0.0055 | 0.0040 | 0.0025 | 0.0010 | 0.0005 |
|---|---|---|---|---|---|---|---|---|
| Mycelium | 1 | 40 | 13 | 23 | 24 | 26 | 34 | 38 |
| diameter | 2 | 41 | 13 | 22 | 25 | 26 | 33 | 39 |
| (mm) | 3 | 41 | 12 | 23 | 24 | 26 | 35 | 38 |
| | 4 | 42 | 13 | 24 | 25 | 28 | 36 | 39 |
| | 5 | 39 | 13 | 22 | 24 | 25 | 32 | 37 |
| | 6 | 40 | 13 | 23 | 24 | 25 | 34 | 38 |
| | 7 | 41 | 13 | 23 | 25 | 25 | 33 | 38 |
| | 8 | 41 | 12 | 22 | 25 | 25 | 32 | 38 |
| | Average | 40.63 | 12.75 | 22.75 | 24.50 | 25.75 | 33.63 | 38.13 |

| Average mycelium | 35.63 | 7.75 | 17.75 | 19.50 | 20.75 | 28.63 | 33.13 |
|---|---|---|---|---|---|---|---|
| growth diameter (mm) | | | | | | | |
| Mycelial inhibition (%) | — | 78.25% | 50.18% | 45.26% | 41.75% | 19.65% | 7.02% |
| Toxic regression | y = 9.0308 + 1.6579x | | | | | | |
| equation | | | | | | | |
| R | 0.9612 | | | | | | |
| EC₅₀ Value (μg/mL) | 0.0037 | | | | | | |
| 95% confidence interval | 0.0028-0.0050 | | | | | | |
| for EC₅₀ | | | | | | | |

As stated above, EC₅₀ values were determined by the fitted regression line of the log-transformed percentage inhibition plotted against the log-transformed fungicide concentration. The lower the EC₅₀ value, the higher the activity. The EC₅₀ value of 0.0037 μg/mL shows that pydiflumetofen provides very high activity against Ustilaginoidea virens (rice false smut).

### Example 2-In Vitro Activity of Pydiflumetofen and Other Active Ingredients Commonly Used for the Control of Rice False Smut (Caused by Ustilaginoidea Virens)

Using the same protocol as for Example 1 (above), the activity of pydiflumetofen against rice false smut was compared to that of other fungicidal active ingredients.

TABLE 2
In vitro activity of pydiflumetofen and other active
ingredients commonly used for the control of rice false
smut (caused by Ustilaginoidea virens)

| Active Ingredient | Toxic Regression Equation | R | EC₅₀ (ppm) |
|---|---|---|---|
| Pydiflumetofen | y = 8.3809 + 1.4430x | 0.9671 | 0.0045 |
| Tebuconazole | y = 7.5202 + 2.2536x | 0.9698 | 0.0761 |
| Epoxiconazole | y = 7.4922 + 1.2067x | 0.9217 | 0.0086 |
| Propiconazole | y = 7.5144 + 1.4888x | 0.9325 | 0.0205 |
| Cyproconazole | y = 7.5042 + 1.7737x | 0.9324 | 0.0387 |
| Metconazole | y = 7.5598 + 1.8451x | 0.9493 | 0.0410 |
| Prothioconazole | y = 3.6948 + 2.6503x | 0.9165 | 3.1079 |

EC₅₀ values were determined by the fitted regression line of the log-transformed percentage inhibition plotted against the log-transformed fungicide concentration. The lower the EC₅₀ value, the higher the activity. The EC₅₀ value of 0.0045 ppm shows that pydiflumetofen provides very high activity against Ustilaginoidea virens (rice false smut) compared to fungicides commonly used to treat rice false smut.

### Example 3-Efficacy of Pydiflumetofen in the Field at 38 Days after Application

Application Method: Foliar Spray
Water Volume: 450 L/ha
Number of Applications: 1
Application Timing: BBCH 45-47

TABLE 3
Field Trial Results at 38 days after application

| | | | | Disease | Control |
|---|---|---|---|---|---|
| | Active | Dose rate | Dose rate | Index (DI) | efficacy (%) |
| Product | Ingredient(s) | (ml/mu) | (gai/ha) | at 38DAA | at 38DAA |
| Control | — | — | — | 2.31 | — |
| MIRAVIS ® | Pydiflumetofen | 20 | Pydiflumetofen: | 0.43 | 81.39 |
| 200SC | solo | | 60 | | |
| MIRAVIS ® | Pydiflumetofen | 25 | Pydiflumetofen: | 0.31 | 86.58 |
| 200SC | solo | | 75 | | |
| TFS + TCZ | Trifloxystrobin + | 40 | TFS: 60 + | 0.37 | 83.98 |
| 30% SC | Tebuconazole | | TCZ: 120 | | |

A scale/index of 0 to 9 was used to define the level of disease severity, wherein 0 represents a healthy plant and 9 represents high levels/severe symptoms of disease. Each plant was graded on this 0 to 9 scale and the Disease Index calculated using the following formula:

Disease Index (DI)=[sum(class frequency×scpre of rating class)]/[(total number of plants)×(maximal disease index)]×100.

The above results show that pydiflumetofen provides good control against rice false smut in the field when used at a lower dose rate (60-75 gai/ha) compared to the industry standard of trifloxystrobin+tebuconazole used at a higher dose rate of 180 gai/ha.

### Example 4-Efficacy of Pydiflumetofen in the Field at 77 Days after Application

Application Method: Foliar Spray
Water Volume: 450 L/ha
Number of Applications: 1
Application Timing: BBCH 45-47

TABLE 4
Field Trial Results at 77 days after application

| | | Dose | | Infected No. | Control |
|---|---|---|---|---|---|
| | Active | rate | Dose rate | of Panicles | efficacy (%) |
| Product | Ingredient(s) | (ml/mu) | (gai/ha) | per plot | at 77DAA |
| Control | — | — | — | 153.0 | — |
| MIRAVIS ® | Pydiflumetofen | 25 | Pydiflumetofen: | 36.0 | 76.47 |
| 200SC | solo | | 75 | | |
| TFS + TCZ | Trifloxystrobin + | 40 | TFS: 60 + | 39.7 | 74.07 |
| 30% SC | Tebuconazole | | TCZ: 120 | | |
| CCZ 40% | Cyproconazole | 15 | Cyproconazole: | 52.3 | 65.80 |
| SC | solo | | 90 | | |
| MTZ 10% | Metconazole solo | 60 | Metconazole: | 71.3 | 53.38 |
| SC | | | 90 | | |
| EPZ 12.5% | Epoxiconazole | 50 | Epoxiconazole: | 50.3 | 67.10 |
| SC | solo | | 93.75 | | |
| TCZ 430 | Tebuconazole | 15 | Tebuconazole: | 42.3 | 72.33 |
| g/l SC | solo | | 96.75 | | |

The above results show that pydiflumetofen provides good control against rice false smut in the field when used at a low dose rate (75 gai/ha) compared to fungicides presently used to control rice false smut, even at 77 days after application.

1. A method of controlling Ustilaginoidea virens on rice plants, said method comprising applying an effective amount of pydiflumetofen, to the plant, plant part, or locus thereof.

2. The method according to claim 1, wherein pydiflumetofen is applied during the reproductive growth stage of the rice plant.

3. The method according to claim 1, wherein pydiflumetofen is applied during the early- to mid-boot stage of rice plant growth.

4. The method according to claim 1, wherein pydiflumetofen is applied during BBCH growth stage 41 to 49 of the rice plant.

5. The method according to claim 1, wherein pydiflumetofen is applied during BBCH growth stage 45 to 47 of the rice plant.

6. The method according to claim 1, wherein pydiflumetofen is applied to the plant, plant part, or locus thereof in an amount from 20 g per hectare to 600 g per hectare.

7. The method according to claim 1, wherein pydiflumetofen is applied to the plant, plant part, or locus thereof in an amount from 50 g per hectare to 100 g per hectare.

8. The method according to claim 1, wherein pydiflumetofen is applied to the plant, plant part, or locus thereof in an amount from 60 g per hectare to to 75 g per hectare.

9. Use of pydiflumetofen, or an agrochemically acceptable salt, isomer, stereoisomer, diastereoisomer, enantiomer or tautomer thereof, to control Ustilaginoidea virens on rice plants.
